(19) United States
(12) Patent Application Publication
(10) Pub. No.: US 2012/0052461 A1
(43) Pub. Date: Mar. 1, 2012

(54) Ergonomic Hand-held Teeth Whitener

(76) Inventor: Howard H. Hayes, Encinitas, CA (US)

(21) Appl. No.: 13/182,202

(22) Filed: Jul. 13, 2011

Related U.S. Application Data
(60) Provisional application No. 61/377,042, filed on Aug. 25, 2010.

(51) Int. Cl. A61C 3/00

(52) U.S. Cl. 433/29

(57) ABSTRACT

A hand-held light emitter for employment in combination with a gel applied to teeth for a whitening enhancement during employment by a user. The device features a housing surrounding an interior cavity holding LED's or other light projecting components which provide illumination to the user's mouth through an aperture communicating with the lights in the interior cavity. A pair of handles extend to a position below the aperture to allow for a proper positioning of the aperture to align with an engagement to the user's mouth. The distance of central portions of the handles providing support for the housing and aperture from an underling support may be varied by rotation of the handles or telescopic engagement.

### FIELD OF INVENTION

This application claims priority to U.S. Provisional Application Ser. No. 61/377042, filed on Aug. 25, 2010 and included herein in its entirety by reference thereto.

The present invention relates generally to cosmetic dentistry. More particularly, the disclosed method and apparatus relate to an ergonomically correct hand-held teeth whitener which provides comfortably downwardly angled grips for the user's hands which, when held in an as-used position during use, also place the device in a proper position for natural convection of the heat from the interior of the device during use.

### BACKGROUND OF THE INVENTION

In recent years dental bleaching, also known as tooth whitening, and has been a very popular cosmetic procedure in dentistry. Children have deciduous baby-teeth which are naturally whiter than their adult teeth which follow. Also, as people age, their adult teeth often become darker due to a number of reasons. One common cause of coloration change is from the mineral structure of the tooth of adults. This occurs as the teeth become older and less porous. Another widespread cause of teeth darkening is staining. Adult and children's teeth can become stained by bacterial pigments, foodstuffs and tobacco. Additionally, certain antibiotic medications (like tetracycline) can lead to unsightly teeth stains or a reduction in the brilliance of the enamel thereby making the teeth appear more yellow or brownish.

The popularity of whiter teeth is due to a number of reasons. Chief among them is advertising, which pushes the concept of whiter teeth being more attractive. This, along with the fact that movie stars and celebrities have whiter teeth than the general population, due to cosmetic procedures, has made teeth whitening by the middle class all the more popular.

The effects of home based bleaching can last for several months, and the professional bleaching much longer, but this can vary depending on the lifestyle of the patient. Whitening will decrease faster if the patient smokes or ingests dark-colored liquids like coffee, tea and red wine.

There are many methods to whiten teeth. Among them are bleaching strips, bleaching pens, bleaching gels, laser bleaching, and natural bleaching. Bleaching strips, pens, and gels have become more common for the at-home user where technical knowledge is not required. Conventionally, at-home whitening is done with a bleaching gel which is applied to the teeth using thin guard trays shaped like the dental arch. Another means for at home whitening is provided by the application of small strips that go over the front teeth. These strips are impregnated with oxidizing agents such as hydrogen peroxide or carbamide peroxide and are used to lighten the shade of the tooth. In use, the oxidizing agent penetrates the porosities of the tooth enamel and oxidizes the captured stain deposits lightening the enamel. When repeated over a period of time, the dentin layer underneath the enamel is also bleached.

Dental professionals generally provide more sophisticated techniques for bleaching of teeth which requires training and expensive equipment. One professional technique is power bleaching. It employs light energy to accelerate the process of bleaching in a dental procedure in the dental office. In the professional technique, the dental professional places a gel on the enamel of the patient's teeth. The gel contains a bleaching agent such as a combination of hydrogen peroxide or carbamide peroxide, along with other proprietary ingredients. Light-emitting equipment is then employed to project light, at frequencies generally between 350 nm to 600 nm, into the patient's mouth. The light acts as a catalyst in combination with the gel quickening the breakdown of the peroxide to create free radicals and accelerating the whitening process of the enamel.

The equipment required to generate the light catalyst is conventionally heavy and generates large amounts of heat in the process of light generation. Because of the expense of such professional equipment, to date, use by patients themselves at home has not become popular. Patients have generally endeavored only to use strips and gels to self-whiten teeth.

While patients might be capable of bleaching procedures using light as a catalyst for their own teeth whitening, the professional equipment can be hard to use and is heavy and expensive. Further, the equipment employs light generation components which conventionally become very hot and proper positioning to obtain proper cooling is a must. This is one reason such equipment is mounted on stands at dental offices. Most such equipment depends to a degree upon convection cooling which will cease if the equipment is not properly positioned during use.

Further, if misused or used improperly, such equipment can be damaged by the heat generated during use and can even start fires.

Because of the weight of the equipment, the cost, and the need for precise positioning for cooling and operation, the ability for patients themselves to buy and employ light catalyst equipment is very limited. Hand holding such devices has been generally awkward and hard to accomplish due to weight and configuration of such device. Also, if held wrong, the patient can suffer physical strain and such positioning can severely impair the cooling of such devices.

Accordingly, there exists an unmet need for a device and method which enables at home users to employ the catalyst from a light-emitting device in combination with gels and other materials used on teeth for in-home teeth whitening. Such a device should be simple to use. Such a device should be light in weight and provide an ergonomic means for the patient to support it in an as-used position emitting light to his mouth. Still further, such a device should be configured to naturally encourage the user to hold the device properly during use to thereby avoid the potential overheating which can happen with convective cooling used by such devices.

With respect to the above, before explaining at least one preferred embodiment of the system for light-based teeth whitening for home-use, it is to be understood that the invention herein is not limited in its application as depicted or taught and to the details of construction and to the arrangement of the components or steps set forth in the following description or illustrated in the drawings. The various apparatus and methods of the invention are capable of other embodiments and of being practiced and carried out in various ways which will be obvious to those skilled in the art once they review this disclosure. Also, it is to be understood that the phraseology and terminology employed herein are for the purpose of description and should not be regarded as limiting in any fashion whatsoever.

As such, those skilled in the art will appreciate that the conception upon which this disclosure is based may readily be utilized as a basis for designing of other devices, methods and systems for carrying out the several purposes of the herein disclosed ergonomically correct teeth whitening device and method. It is important, therefore, that the objects and claims be regarded as including such equivalent construction and methodology insofar as they do not depart from the spirit and scope of the present invention.

### SUMMARY OF THE INVENTION

The present invention is directed to a lightweight, ergonomically correct, hand-held, light emitter for employment as a catalyst in combination with a gel or liquid on the teeth enamel, during an in-home teeth whitening by a user. If the light emitters are such that they emit light that is adapted to whiten enamel without any material applied, it may be used for that purpose also. The device employs a means for light transmission which emits light at a frequency adapted to be a catalyst for the gel or other liquid material that is applied to the patient's teeth. The light, when employed during the whitening process, speeds up as well as enhances the whitening process.

The device features a housing that houses the electronics and light-emitting components in an interior cavity. A fan may be provided to aid in cooling which is also provided by natural convection when the housing is held upright in the as-used position by a patient user.

Particularly preferred in the current mode of the device are a pair of projecting handles which extend in opposite directions from the exterior of the housing. In a particularly preferred mode of the device, the handles angle downward from the housing when it is held in front of a patient in an as-used position. The downward angle of the handles allows the user to hold the housing with the light-emitting aperture in front of the patient's mouth, and with the hands lower than his mouth, while gripping the handles. This allows the patient to keep his arms lower than he might if the handles extended outward level with the centerline of the housing, or if the handles extended upward.

During use, the downward slant of the handles places the gripped center portion of both handles lower than the mouth such that a sitting patient may place his elbows on his abdomen or the tops of his legs and thereby obtain support for the weight of the housing and device without using muscles. Were the handles extending level or upward, the patient quite likely would have to hold the device elevated with no support for his elbows which at best would be tiring.

The downward slant or curve of both opposing handles also provides a means to encourage use of the device in a proper position to allow for convective cooling of the internal components. Light-emitting bulbs and light-emitting diodes both generate a substantial amount of heat during use. Positioned within an internal cavity of the housing, this heat can reach dangerous levels without some form of cooling.

The device employs an elongated heat sink with fins positioned in between intake and exhaust vents of the housing. Longer fins are positioned on an upper surface of the elongated member portion of the heat sink which communicates heat from the light-emitting diodes LED's to the larger fins projecting above the elongated member. Slots formed below the heat sink communicate cool air into the internal cavity which is heated first by small lower fins which causes the cool air to rise. The air encounters the larger fins of the heat sink and is accelerated upward on its way to a communication through upper vents in the housing and to the exterior. A fan can be provided to augment the airflow toward the upper vent.

This configuration of the device, in the as-used position, with the handles angling or curving downward, cools the device naturally. This natural cooling occurs well as long as the device is held in the proper position during use. By employing the downwardly projecting handles, the device encourages holding the housing in the proper position since the user is much more comfortable holding the device with the handles downward and his elbows supported on his lap or abdomen than he would be supporting the device without such elbow support. Consequently, the potential for overheating is greatly reduced and the user also benefits from the support for his arms, afforded by lowering the position of the hands relative to the housing.

Further, to allow the user to better position his arms in the as-used position, on a table, or his lap for instance, the device may be equipped with the downward angled handles which are telescopic. This will allow users, who of course vary in arm length dimensions, to adjust the length to allow them to position their elbows on a support surface while employing the device for the number of minutes required.

Additionally provided to augment use in home by a patient, is a removable mouth piece to allow other patients to engage their own mouthpiece during use. This eliminates the chance of bacteria and germs being passed between different users.

Further provided is an onboard microprocessor which is button-activated to energize the light-emitting diodes, or other light source, only for the duration necessary for a given procedure. Software adapted to the task runs on the microprocessor and allows for push button operation and timing of the device. Also provided in a preferred mode, but optional, is a positioning switch such as a simple mercury switch. The positioning switch prevents use of the device if upside down with the handles extending in an upward angle to thereby prevent overheating.

The foregoing has outlined, rather broadly, the more pertinent and important features of the dental bleaching catalyst light herein, in order that the detailed description of the invention that follows may be better understood so that the present contribution to the art may be more fully appreciated. It should be appreciated by those skilled in the art that the conception, and the disclosed specific embodiments herein, may of course be readily utilized as a basis for providing other dental bleaching catalyst lights for carrying out the same purposes of the present invention. It should also be realized by those skilled in the art that such equivalent systems and methods are considered within the spirit and scope of the invention as set forth herein.

### THE OBJECTS OF THE INVENTION

It is therefore an object of the present invention to provide a lightweight dental bleaching light device which may be employed in home by a patient.

It is an additional object of this invention is to provide such a light catalyst which has handles which encourage use in a proper position for cooling of the device.

A further object of the dental light catalyst is the provision of downwardly extending handles which afford the user the ability to support his arms on his abdomen or legs during use.

Yet another object of this invention is the provision of such a bleaching catalyst light which prevents holding during use in the wrong position, which could cause overheating.

Yet a further object of the invention is the provision of such a device that is protected from use by children through switching devices designed therefore.

While all of the fundamental characteristics and features of the disclosed light device for augmenting a dental bleaching procedure have been described herein, with reference to particular embodiments thereof, a latitude of modification, various changes and substitutions are intended in the foregoing disclosure and it will be apparent that in some instance some features of the invention will be employed without a corresponding use of other features without departing from the scope of the invention as set forth.

It should be understood that such substitutions, modifications, and variations may be made by those skilled in the art without departing from the spirit or scope of the invention. Consequently, all such modifications and variations are included within the scope of the invention as defined herein.

### BRIEF DESCRIPTION OF DRAWING FIGURE

FIG. 1 is a perspective view of an especially preferred mode of the device having adjustable handles.

FIG. 2. is a top view of the device as in FIG. 1 showing the controls.

FIG. 3 depicts a perspective view of the device in the as-used position, showing the electronic control buttons on a top surface and downwardly projecting handles.

FIG. 3a shows removable mouthpiece engageable to one end of the housing.

FIG. 4 is an end view of the device in the as-used position showing the aperture engaged with the patient's mouth for communication of light therethrough at a distance along a line perpendicular to a line running between the position of central portions of the handles.

FIG. 5 is a side view of the device in the as-used position.

FIG. 6 is a sectional view through FIG. 5 showing the internal components for convective heat dissipation and the onboard microprocessor, fan, and light-emitting diodes and the biased mouthpiece and depression sensor safety switching.

### DETAILED DESCRIPTION OF THE PREFERRED EMBODIMENTS OF THE INVENTION

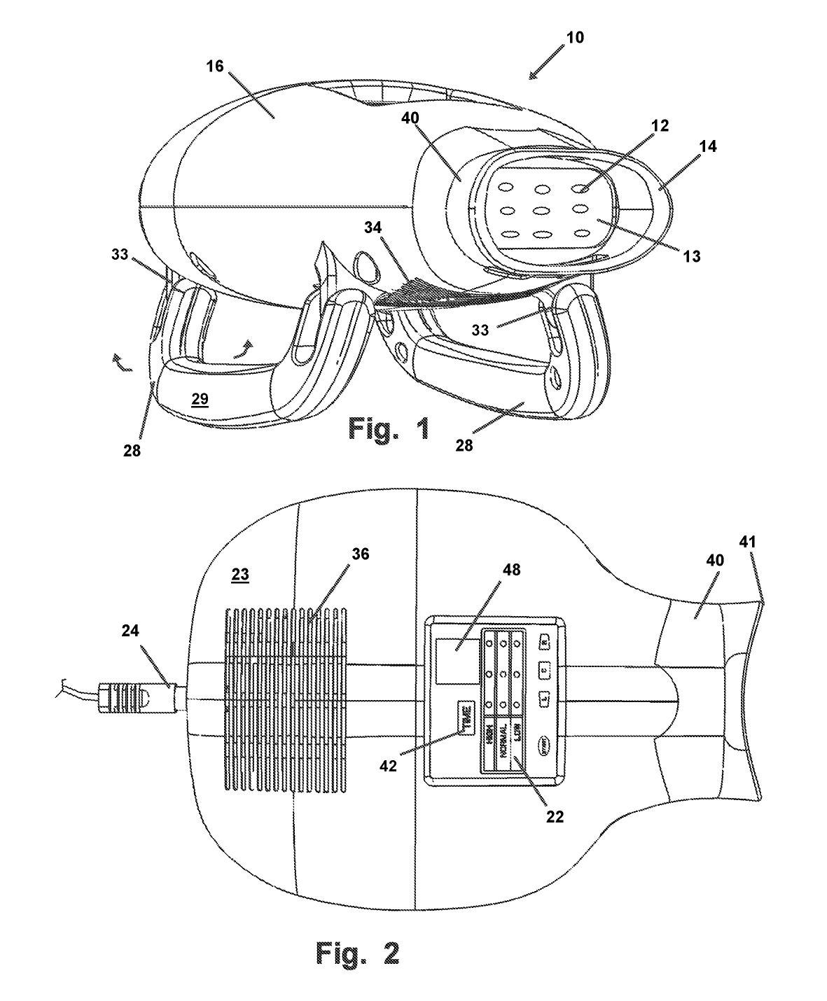

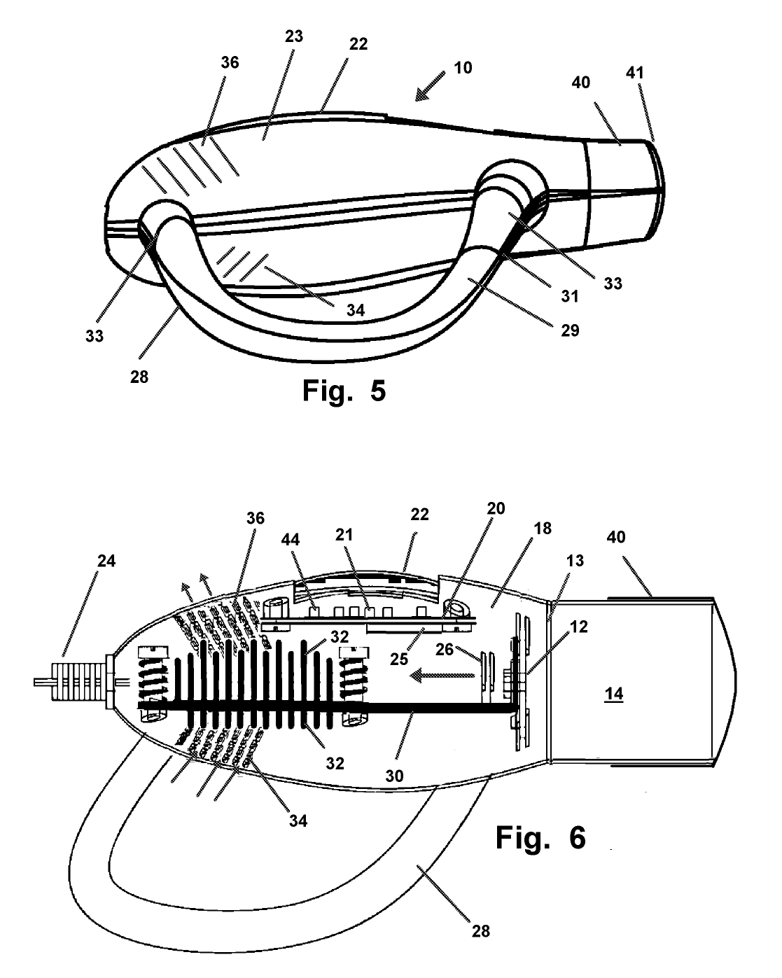

Referring now to FIGS. 1-6 there is seen in FIG. 1, a perspective view of a particularly preferred mode of the device 10. In all modes of the device 10 are operatively engaged a means for blue light transmission such as LED's 12 which emit high-intensity blue light preferably in a wavelength of 460-520 Nanometers. The light in this range operates in concert with a gel applied to the teeth of the user to cause the enamel of their teeth to whiten. The light from the LED's 12 is communicated through a lens, and then an aperture 14 located at a first end of the housing 16 which is configure for engagement with the user's lips which communicates through an aperture 14 allowing the communication of light from the device 10 and into a user's mouth engaged upon the area of the aperture 14.

The housing 16 in all modes of the device 10 defines an interior cavity 18 to hold the operative components therein such as the battery 25 for portable versions, and a heat sink 30 for venting of heat from the LED's 12 using movement of air from intake vents 34 past the heat sink 30, exiting the exhaust vents 36 (FIG. 6). In use with the LED's illuminated, heat is removed from the device 10 by employing rising air from the intake vents 34 which is drafted to encounter the fins of the heat sink 30. The air, after a heat exchange during interaction with the heat sink 30 which is operatively engaged with the LED's 12, exits through the exhaust vents 36 in the top surface 23 of the housing 16.

The LED's 12 or other operative light source, emit light in the blue light frequency range which is focused through a lens 13, or directly through the aperture 14 at a frequency adapted to be a catalyst for the gel or other liquid material that is applied to the patient's teeth. Currently preferred are LED's 12 which emit light at a frequency between 350 nm to 600 nm depending upon the gel or liquid applied to the patient's teeth and which frequency is best adapted to work in concert therewith to enhance the whitening process. A favored light frequency in this range is between 460 and 520 nm however this may be adapted when a gel employed for use in combination herewith changes.

The device 10 employs an exterior keypad 22 which is operatively engaged with an internal circuit board forming an control 20 (FIG. 6). The LED's 12, electronic control 20, and other components are in operative wired communication with incoming AC power 24 allowing the device to be plugged into a socket for operation, or to charge a battery 25 (FIG. 4) which is operatively engaged thereto in the preferred mode of FIGS. 1-2 which employ a battery 25 for portability. Power to the LED's 12 or other means for blue light illumination at the proper frequency, is by wired communication with a power supply on or engaged with the electronic control 20 or from the battery 25 which would be charged during or when the device 10 is not in use. Although the device 10 is operatively configured to be cooled by natural convection using the arrangement of vents, a fan may be provided to aid in cooling and draw heat away from the light source such as the LED 12.

As shown in FIGS. 1-2, the device has adjustable handles 28 which are rotationally engaged with the housing 16 at a mount 33. The pair of projecting handles 28 extend away from the housing 16 in opposite directions and because they rotate in an enagement to the mounts 33, they may be user-adjusted to a comfortable downward or away from the top surface 23 of the housing 16 when the device 10 is in the as-used position held in front of a patient's face by their hands gripping the handles 28 or positioned on a table or support surface with the handles 28 supported thereby. By employing a rotational engagement of the handles 28, a means for ajustment of the downward angle of the handles 28 is provided.

This user adjustable means for angle ajustment of the handles 28 is particularly preferred in that it allows the patient to hold the housing 16 in the as-used position with the light-emitting aperture 14 in front of the patient's mouth and more easily support the device with the user's arms, or ajust the angle so allow the user to support the user's arms on an underlying support surface, while still aligning the aperture 14 for an enagement with their mouth, all in a comfortable position for the duration of time required.

Rotating the handles to place both handles 28 closer to each other, and under the housing 16, will raise the device 10 to positon the aperture 14 vertically higher from an imaginary line “A” running between the central portions 29 of the handles 28 where the user's griping hands (FIG. 4) are located. Alternatively, placing the handles 28 at an angle to position them towards the sides of the housing 16, (such as in FIG. 4) and further from each other, will position the aperture 14 along a perpendicular line, closer to the imaginary line “A” running between their hands when gripping the handles 28.

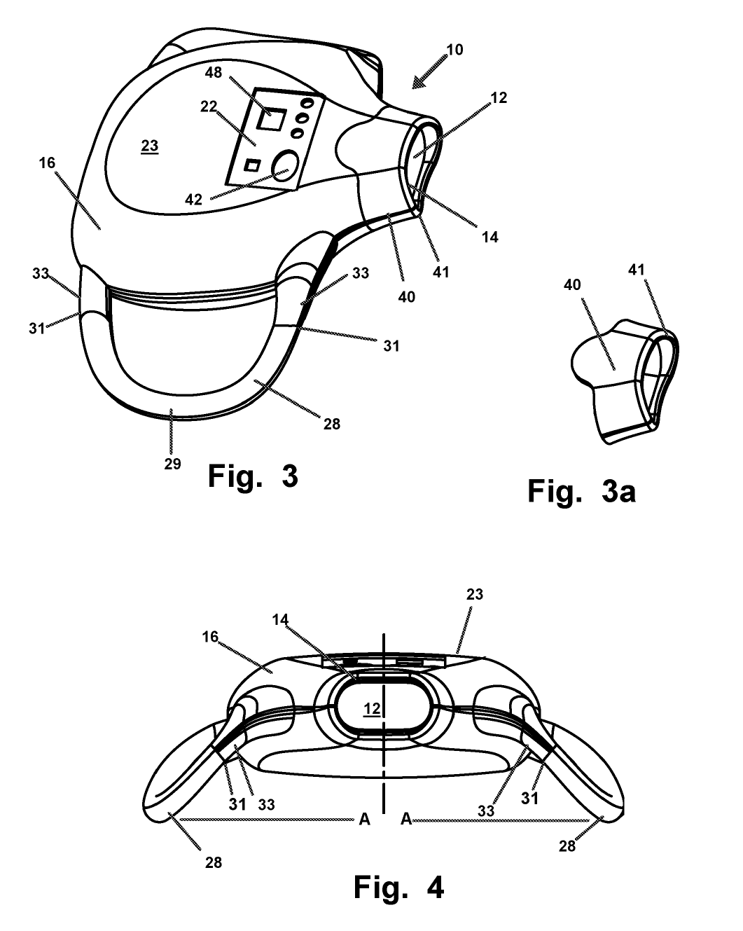

Referring now to FIG. 3, a perspective view of another mode of the disclosed device 10, having fixed handles 28 can be seen. The device 10 in FIG. 3, as in all modes herein, features the means for blue light transmission such as LED's 12 which emit blue light through an aperture 14 located at a first end of the housing 16. The emitted light as noted is at a frequency adapted to work with the gel employed herewith on the user's teeth.

The housing 16 in the fixed handle 28 mode, is configured in the same fashion as that of FIG. 1, and is adapted to hold the operative components within an internal cavity 18 (FIG. 6). In the same fashon as the device 10 of FIG. 1, light from the LED's 12, communicates through the aperture 14 with the exterior of the device 10, either directly, or through a lens 13.

The device 10 as shown in FIG. 3, employs the housing 16 to surround the requisite electronic control 20 (FIG. 6) which communicates and is also operated by the patient using an exterior keypad 22. The electronic control 20 in all modes of the device 10, may have timed routines for the patient to choose or may allow for independent settings by the patient.

In FIGS. 3-6, the pair of projecting handles 28 extend away from the housing 16 in opposite directions at an angle downward or away from the top surface 23 of the housing 16 where the keypad 22 resides when the device 10 is in the as-used position held in front of a patient by his hands on the handles 28 and with the aperture 14 aligned with the user's mouth. The downward angle of the handles 28 best seen in FIG. 4, is preferred as it allows the patient to hold the housing 16 in the as-used position with the light-emitting aperture 14 in front of the patient's mouth, yet more easily support his arms at the elbow on an underlying support surface. The downward angle of the handles 28 afford the user the ability to keep his arms lower than they might if the handles extended parallel to the top surface 23, or at an upward angle therefrom and exert the force of the weight of the device 10 downward when gripped.

Optionally, the handles 28 in all modes of the device 10, may be configured for adjustable length using a telescopically engaged handle central portion 29. The central portion 29 can be extended away from the housing 16 at telescopic connections 31 to housing mounts 33 engaging the housing 16. The telescoping sections provide a means for adjustment of the length of the distance of the middle portion 29, of the handles 28, where they are gripped by the patient in the as-used position. If employed with the mode in FIG. 1, portions of the handle 28 adjacent to the central portion 29 leading to the mounts 33 can be made telescopically expanding thereby allowing for moving the central portion 29 further or closer to the housing 16.

This adjustment of the distance of the central portion 29 of the handles 28 closer to, or further from the housing 16, allows the patient with shorter arms to lengthen the handles 28 to let him position the aperture 12 in communication with his mouth, while still supporting his elbows on a support surface such as a table, his lap, or his abdomen. Patients with longer arms, could reverse the process and make the handles 28 shorter to allow them to comfortably support their elbows while gripping the handles 28 and aligning the aperture 14 with their mouth.

Also, as noted, this configuration of both opposing handles 28 provides a means to encourage use of the device in a proper position, with the top surface 23 upward and thereby assure proper airflow for convective cooling. Light-emitting bulbs and light-emitting diodes or LED′S 12 both generate a substantial amount of heat during use which can raise the cavity temperature above safe operating conditions. Therefore a means to ensure proper upright positioning, as well as proper posture of the user, which is provided by telescopic adjustment of the handles 28, rotational adjustment of the handles 28, or a combination of both, is a preferred component of the device 10.

As noted, cooling of the internal cavity by convection is provided using an elongated heat sink 30 with cooling fins 32 positioned in between air passing from intake vents 34 to the exhaust vents 36 of the housing 16. The heat sink 30 is especially well adapted for convection cooling when the device 10 is in the as-used position by positioning longer fins 32 on an upper surface of the elongated member 33 portion of the heat sink 32 which communicates heat from a portion of the member 33 in contact with a surface of the LED' 12. The intake vents 34 formed through the housing 16 below the heat sink 32, communicate cool air into the internal cavity 18 which is heated first by smaller fins 32 extending away from the top surface 23 and this encourages the cool air to rise. The rising air encounters the larger fins 32 extending toward the top surface 23 from the member 33 portion of the heat sink 32 and is heated further to cause it to accelerate upward on its way to a communication through the exhaust vents 36 in the top surface 23 of the housing 16. As noted, a fan 26 can be provided to augment the airflow toward the upper vents 36 or if different airflow patterns are desired. The components of the device 10 so arranged with the device 10 in the as-used potion, with the handles 28 in the downward angle, positions the device 10 for maximum natural cooling by convection.

Also especially preferred, in all modes of the device 10 is a removable mouth piece 40. This will allow the device 10 to engage with one or a plurality of such mouthpieces 40 so that multiple users of the device 10 may employ their own mouthpiece for sanitary reasons. Further, some patients may have mouths that are smaller and need a distal end 41 of the mouthpiece adapted to their mouth size. The device 10 thus can be provided with a kit of a plurality of mouthpieces 40 each having a different diameter end portion 41 to allow for patient mouth size adjustments.

On the electronic control 20 in a preferred configuration of the device 10 is an onboard microprocessor 21 and memory and other components adapted to run software loaded to the device 10 to aid the user to operate the device 10. The microprocessor 21 is activated to turn the device on and run the menu-driven software when a button such as time button 42 on the keypad 22 is depressed when the user or patient wishes to activate the LED 12 to emit the light for a whitening session.

Software adapted to the task may be enabled on the microprocessor 21 to operate the device 10 in pre-programmed modes of operation for proper time and duration, to work with the gel or liquid or other material on the patient's teeth and according to the suggested times, light levels, and light frequency required for best performance of the device 10 for the patient. Further, as a failsafe to insure proper positioning of the device 10 for cooling, it may be equipped with a position sensor 44 which ascertains if the device 10 is positioned with the top surface 23 upward and handles angled downward toward the support surface. This position sensor 44 will continually ascertain if the device is in the as-used proper position for operation and cooling by convection and prevent energizing of the light emitters or LED's if the device 10 is wrongly positioned such as upside down. An LCD display 48 may be provided with a message such as “turn the device over” so that the patient is aware of his mis-positioning of the device 10. The LCD display 48 may also operate to provide instructions and information to the patient from the software running on the microprocessor 21 during use or a countdown timer showing the duration left in a session.

Also shown in FIG. 6 is one preferred mode of prevention of use of the device 10 by a child in the form of the biased positioned mouthpiece 40 translationally engaged to the housing 16. The mouthpiece 40 is biased away from the housing 16 by a biasing means such as a spring 51. A position sensor 53 acts in concert with a switch 53 to interrupt electrical power to the LED 12 to prevent it from illuminating unless the mouthpiece 40 is depressed to overcome the bias of the spring 51 and position the mouthpiece 40 such that the position sensor 53 detects the translation of the mouthpiece. The position sensor 53 may be light activated using apertures in both the mouthpiece 40 and housing 16, or may be magnetic, or any other means to sense the proper position of the mouthpiece 40 as would occur to those skilled in the art. This illumination prevention scheme is preferred because it is unlikely a child will have the ability to depress the mouthpiece 40 of the device 10 and can also be employed in combination with the position sensor 44 whereby the device 10 must be both in the proper position, and with the mouthpiece 40 depressed, to activate the LED for illumination.

While all of the fundamental characteristics and features of the disclosed method and apparatus for emitting light to act as a catalyst during teeth whitening, with reference to particular embodiments thereof, are disclosed herein, a latitude of modification, various changes and substitutions are intended in the foregoing disclosure. Further, it will be apparent that in some instance, some features of the invention may be employed without a corresponding use of other features, or steps may be rearranged for operations, without departing from the scope of the invention as set forth. It should be understood that such substitutions, modifications, and variations as may be made by those skilled in the art, without departing from the spirit or scope of the invention, are included within the scope of the invention as defined herein by the claims that follow.

What is claimed is:

1. A hand-held light emitter for employment in combination with a gel applied to teeth during a teeth whitening session by a user, comprising:
a housing surrounding an interior cavity;
an aperture communicating with said interior cavity, said aperture positioned at a first end of said housing;
means for light generation positioned within said interior cavity in operative communication with an electrical power source;
means for engagement of said aperture, with the face area surrounding the open mouth of said user, said open mouth exposing teeth therein;
a pair of handles engaged to said housing, said handles extending away from engagement points with said housing to central portions;
said central portions of said handles configured to support said housing overhead, in an as-used position;
said central portions positioned with said aperture a distance above a substantially horizontal line running through said central portions, with said housing in said as-used position; and
said means for light generation projecting light at a frequency adapted to act in concert with said gel applied to said teeth during said teeth whitening session with said housing in said as-used position, whereby said user may employ said light emitter to enhance a whitening of said teeth.

2. The hand-held light emitter of claim 1, additionally comprising:
said handles extending at a descending angle from an axis running through said aperture and said housing; and
a perpendicular line running from said axis at its intersection point with said horizontal line running through said central portions, defining said distance of said aperture above said horizontal line.

3. The hand-held light emitter of claim 1, additionally comprising:
said handles in a rotational engagement with said housing; and
rotation of said handles providing means to vary said distance of said aperture above said horizontal line thereby providing means to position said aperture further from or closer to the support for said central portion of said handles, whereby a user may adjust the position of said aperture to render the device comfortable to employ in the as-used position.

4. The hand-held light emitter of claim 2, additionally comprising:
said handles in a rotational engagement with said housing; and
rotation of said handles providing means to vary said distance of said aperture above said horizontal line thereby providing means to position said aperture further from or closer to the support for said central portion of said handles, whereby a user may adjust the position of said aperture to render the device comfortable to employ in the as-used position.

5. The hand-held light emitter of claim 1, additionally comprising:
said handles in a telescopic engagement with said housing allowing for a varying of positioning of said central portions to thereby vary the distance of said aperture above said horizontal line.

6. The hand-held light emitter of claim 2, additionally comprising:
said handles in a telescopic engagement with said housing allowing for a varying of positioning of said central portions to thereby vary the distance of said aperture above said horizontal line.

7. The hand-held light emitter of claim 3, additionally comprising:
said handles in a telescopic engagement with said housing allowing for a varying of positioning of said central portions to thereby vary the distance of said aperture above said horizontal line, whereby a user may adjust the position of said aperture to render the device comfortable to employ in the as-used position through one or a combination of a rotation of said handles or an employment of said telescopic engagement to vary said positioning of said central portions of said handles.

8. The hand-held light emitter of claim 1 wherein said means for engagement of said aperture with the face area surrounding the open mouth of said user comprises:
a mouthpiece engaged at a first end to said housing and defining a passage terminating at an edge; and
said edge configured for engagement with lips of said user and to concurrently hold said mouth of said user, open.

9. The hand-held light emitter of claim 2 wherein said means for engagement of said aperture with the face area surrounding the open mouth of said user comprises:
a mouthpiece engaged at a first end to said housing and defining a passage terminating at an edge; and
said edge configured for engagement with lips of said user and to concurrently hold said mouth of said user, open.

10. The hand-held light emitter of claim 1 wherein said means for engagement of said aperture with the face area surrounding the open mouth of said user comprises:
a mouthpiece removably engaged at a first end to said housing and defining a passage terminating at an edge;
said edge configured for engagement with lips of said user and to concurrently hold said mouth of said user open; and
said mouthpiece from a plurality of said mouthpieces having one or a plurality of variable sized said edges to accommodate variable sizes of user mouths, whereby multiple users may employ a respective said mouthpiece during a said teeth whitening session and accommodate a size of their mouth and maintain a sanitary condition by a solo employment of said respective mouthpiece.

11. The hand-held light emitter of claim 2 wherein said means for engagement of said aperture with the face area surrounding the open mouth of said user comprises:
a mouthpiece removably engaged at a first end to said housing and defining a passage terminating at an edge;
said edge configured for engagement with lips of said user and to concurrently hold said mouth of said user open; and
said mouthpiece from a plurality of said mouthpieces having one or a plurality of variable sized said edges to accommodate variable sizes of user mouths, whereby multiple users may employ a respective said mouthpiece during a said teeth whitening session and accommodate a size of their mouth and maintain a sanitary condition by a solo employment of said respective mouthpiece.

13. The hand-held light emitter of claim 3 wherein said means for engagement of said aperture with the face area surrounding the open mouth of said user comprises:
a mouthpiece removably engaged at a first end to said housing and defining a passage terminating at an edge;
said edge configured for engagement with lips of said user and to concurrently hold said mouth of said user open; and
said mouthpiece from a plurality of said mouthpieces having one or a plurality of variable sized said edges to accommodate variable sizes of user mouths, whereby multiple users may employ a respective said mouthpiece during a said teeth whitening session and accommodate a size of their mouth and maintain a sanitary condition by a solo employment of said respective mouthpiece.

14. The hand-held light emitter of claim 4 wherein said means for engagement of said aperture with the face area surrounding the open mouth of said user comprises:
a mouthpiece removably engaged at a first end to said housing and defining a passage terminating at an edge;
said edge configured for engagement with lips of said user and to concurrently hold said mouth of said user open; and
said mouthpiece from a plurality of said mouthpieces having one or a plurality of variable sized said edges to accommodate variable sizes of user mouths, whereby multiple users may employ a respective said mouthpiece during a said teeth whitening session and accommodate a size of their mouth and maintain a sanitary condition by a solo employment of said respective mouthpiece.

15. The hand-held light emitter of claim 5 wherein said means for engagement of said aperture with the face area surrounding the open mouth of said user comprises:
a mouthpiece removably engaged at a first end to said housing and defining a passage terminating at an edge;
said edge configured for engagement with lips of said user and to concurrently hold said mouth of said user open; and
said mouthpiece from a plurality of said mouthpieces having one or a plurality of variable sized said edges to accommodate variable sizes of user mouths, whereby multiple users may employ a respective said mouthpiece during a said teeth whitening session and accommodate a size of their mouth and maintain a sanitary condition by a solo employment of said respective mouthpiece.

16. The hand-held light emitter of claim 6 wherein said means for engagement of said aperture with the face area surrounding the open mouth of said user comprises:
a mouthpiece removably engaged at a first end to said housing and defining a passage terminating at an edge;
said edge configured for engagement with lips of said user and to concurrently hold said mouth of said user open; and
said mouthpiece from a plurality of said mouthpieces having one or a plurality of variable sized said edges to accommodate variable sizes of user mouths, whereby multiple users may employ a respective said mouthpiece during a said teeth whitening session and accommodate a size of their mouth and maintain a sanitary condition by a solo employment of said respective mouthpiece.

17. The hand-held light emitter of claim 7 wherein said means for engagement of said aperture with the face area surrounding the open mouth of said user comprises:
a mouthpiece removably engaged at a first end to said housing and defining a passage terminating at an edge;
said edge configured for engagement with lips of said user and to concurrently hold said mouth of said user open; and
said mouthpiece from a plurality of said mouthpieces having one or a plurality of variable sized said edges to accommodate variable sizes of user mouths, whereby multiple users may employ a respective said mouthpiece during a said teeth whitening session and accommodate a size of their mouth and maintain a sanitary condition by a solo employment of said respective mouthpiece.

18. The hand-held light emitter of claim 5 wherein said means for engagement of said aperture with the face area surrounding the open mouth of said user comprises:
a mouthpiece engaged at a first end to said housing and defining a passage terminating at an edge; and
said edge configured for engagement with lips of said user and to concurrently hold said mouth of said user, open.

19. The hand-held light emitter of claim 6 wherein said means for engagement of said aperture with the face area surrounding the open mouth of said user comprises:
a mouthpiece engaged at a first end to said housing and defining a passage terminating at an edge; and
said edge configured for engagement with lips of said user and to concurrently hold said mouth of said user, open.

20. The hand-held light emitter of claim 7 wherein said means for engagement of said aperture with the face area surrounding the open mouth of said user comprises:
a mouthpiece engaged at a first end to said housing and defining a passage terminating at an edge; and
said edge configured for engagement with lips of said user and to concurrently hold said mouth of said user, open.

21. The hand-held light emitter of claim 8 further comprising:
said mouthpiece translationally engaged to said housing for a movement between a depressed position and a static position translated in a direction away from said housing;
means to bias said mouthpiece to said static positon; and
a position sensor configured to interrupt said operative communication of said means for light generation with said electrical power source when said mouthpiece is in said static position.

22. The hand-held light emitter of claim 9 further comprising:
said mouthpiece translationally engaged to said housing for a movement between a depressed position and a static position translated in a direction away from said housing;
means to bias said mouthpiece to said static position; and
a position sensor configured to interrupt said operative communication of said means for light generation with said electrical power source when said mouthpiece is in said static position.

24. The hand-held light emitter of claim 22 further comprising:
a position sensor, said position sensor interrupting communication between said light emitter and said electrical power source unless said housing is concurrently supported in said as-used position.

25. The hand-held light emitter of claim 23 further comprising:
a position sensor, said position sensor interrupting communication between said light emitter and said electrical power source unless said housing is concurrently supported in said as-used position.
